(19) United States
(12) Patent Application Publication
(10) Pub. No.: US 2013/0027288 A1
(43) Pub. Date: Jan. 31, 2013

(54) LED BACKLIGHT AND LIQUID CRYSTAL DISPLAY DEVICE

(71) Applicants: Naoto Inoue, Osaka-shi (JP); Akira Tomiyoshi, Osaka-shi (JP); Tomohiko Yamamoto, Osaka-shi (JP)

(72) Inventors: Naoto Inoue, Osaka-shi (JP); Akira Tomiyoshi, Osaka-shi (JP); Tomohiko Yamamoto, Osaka-shi (JP)

(21) Appl. No.: 13/641,751

(22) PCT Filed: Feb. 4, 2011
(86) PCT No.: PCT/JP2011/052351

§ 371 Date: Oct. 17, 2012

(30) Foreign Application Priority Data
Apr. 28, 2010 (JP) 2010-102938

(51) Int. Cl. G09G 3/36

(52) U.S. Cl. 345/102

(57) ABSTRACT

Disclosed are a direct-lit LED backlight, and a liquid crystal display device, provided with the backlight. In the LED backlight, heat generated by LEDs is easily dissipated, the number of the LEDs disposed is reduced, the temperature of the LEDs does not become too high, and reliability is improved by stabilizing light emission luminance and service life. The LED backlight (BL1) is provided with: an LED substrate (2), on which a plurality of the LEDs (1) are arranged in a row in the axis line direction; and a base (3), which has a substrate attaching surface (3a) for attaching the LED substrate. The base (3) is attached to a frame (10) such that the axis line direction is in the perpendicular direction, and a flow channel where air flows is provided in the perpendicular direction on the rear side of the substrate attaching surface (3a) of the base (3).

### TECHNICAL FIELD

The present invention relates to a backlight that irradiates an liquid crystal panel with light from behind and to a liquid crystal display device provided with such a backlight. More particularly, the invention relates to an LED backlight and a liquid crystal display device that use an LED as a light source.

### BACKGROUND ART

In recent years, as their light emission efficiency improves and their light emission amount increases, LEDs (light emitting diodes), which are said to have long lives, consume little electric power, and be environment-friendly, have come to be increasingly used in lighting devices in practical use. On the other hand, since the advent of blue light emitting LED chips, white LED light sources have been developed like those which produce white light by combination of such a blue LED chip with a phosphor that emits excitation light of a predetermined wavelength by being excited by the light from the LED chip and those which synthesizes white light by use of LED chips of three primary colors that are a blue LED chip, a green LED chip, and a red LED chip.

Thus, as backlights for liquid crystal display devices and the like, LED backlights that incorporate a white LED light source are available. Backlights for liquid crystal display devices include those of a direct-lit type which have a light source arranged on the back face of the display screen and those of an edge-lit type which have a light source arranged at the side of the display screen and in addition a light guide plate provided on the back face of the display screen wherein light is introduced into the light guide plate from the side of the display screen so as to be repeatedly reflected inside the light guide plate and eventually emerge as planar light from the light emission surface of the light guide plate.

Edge-lit backlights have a construction where a light source is provided at the side of the display screen and a plate-form light guide plate is provided behind the display screen; they are thus easy to make slim and are preferable in making liquid crystal display devices and the like slim. On the other hand, direct-lit backlights have a light source provided on the back face of the display screen to illuminate it directly; they thus make it easy to achieve high-luminance illumination, and also make it easy to control light emission luminance area by area.

Among direct-lit backlights using an LED, some known backlights have, with a view to reducing the number of LEDs provided, a construction where an LED is combined with an inclined reflective surface (see, for example, Patent Document 1). In this conventional backlight, for example as shown in FIG. 13, an LED board 2C, a diffuser plate 5, and a liquid crystal panel 6 are arranged on a frame member 10; the parts of the LED board 2C on both sides of its bottom part on which the LED 1 is provided are inclined, and on their light emission-side surface, a reflective sheet 4C having a reflective surface 4Ca is provided.

Thus, in a liquid crystal display device 14 provided with a backlight BL4 having this construction, the light emitted from the LED light source is reflected by the reflective surface 4Ca over a wide area. This helps make backlights compact.

### LIST OF CITATIONS

### Patent Literature

Patent Document 1: JP-A-2002-49036

### SUMMARY OF INVENTION

### Technical Problem

Using fewer LEDs causes electric power to concentrate on the fewer LEDs and makes their temperature prone to be high. At high temperature, the LEDs have diminished light emission efficiency, making it impossible to obtain the desired light emission luminance, and shorter lives. Thus, under poor heat dissipation, the LEDs have notably shorter lives and hence lower reliability.

Moreover, to increase the efficiency of use of the light of LEDs, or to prevent inconveniences like foreign matter such as dust entering between the backlight and the liquid crystal panel and being displayed on the screen, generally, the LED accommodation portion is made airtight.

As a result, conventional direct-lit LED backlights often suffer from poor dissipation of heat from LEDs. Patent Document 1 mentioned above discusses using an LED and a reflective surface for size reduction but teaches no scheme of improving the dissipation of heat from LEDs and thereby prolonging their lifetime.

Against the background described above, the present invention aims to devise, in direct-lit LED backlights and liquid crystal display device provided therewith, a construction that allows easy dissipation of the heat generated by LEDs in order to provide an LED backlight that, even when fewer LEDs are provided and electric power concentrates on the fewer LEDs, prevents the temperature of the LEDs from becoming excessively high and that can stabilize light emission luminance and lifetime and thereby improve reliability.

### Solution to Problem

To achieve the above object, according to the present invention, an LED backlight that is fitted to a frame member of a liquid crystal display device provided with a liquid crystal panel and that irradiates the liquid crystal panel from behind with light emitted from LEDs is provided with: an LED board on which a plurality of the LEDs are mounted in one axial direction; and a base to which the LED board is fitted. The base has a board fitting face to which the LED board is fitted such that the LEDs are exposed to a light emission region between the LEDs and the liquid crystal panel and a side frame portion which forms, behind the board fitting face, a hollow space that is isolated from and does not communicate with the light emission region. The base is fitted to the frame member with the one axial direction aligned with the plumb-line direction such that, in the hollow space, a passage that runs in the plumb-line direction is formed through which air passes.

With this construction, even when the plurality of LEDs arranged in the plumb-line direction generate heat, an ascending current occurs in the passage formed in the plumb-line direction behind the base to exert the chimney effect, and the air passing through the passage allows easy heat dissipation. Thus, it is possible to obtain an LED backlight that prevents the temperature of the LEDs from becoming excessively high and that can stabilize light emission luminance and lifetime and thereby improve reliability.

According to the present invention, in the LED backlight constructed as described above, the base has a square-cornered C-shaped cross section by being composed of the board fitting face, which extends in the plumb-line direction, and side frames, which are provided on both sides of the board fitting face and are bent approximately perpendicularly therefrom. The open part of the square-cornered C-shaped cross section serves as the passage. With this construction, even when the light emission region between the back of the liquid crystal panel and the LED accommodation portion is formed as an airtight space, an air passage with a “square-cornered C-shaped” cross section is formed behind the LED accommodation portion, and thus air current through the air passage allows easy heat dissipation.

According to the present invention, in the LED backlight constructed as described above, the base is in the form of a rectangular pipe having a rectangular cross section by being composed of the board fitting face, which extends in the plumb-line direction, and three side frames, which are contiguous with the board fitting face. The hollow part inside the rectangular cross section serves as the passage. With this construction, even when the light emission region between the back of the liquid crystal panel and the LED accommodation portion is formed as an airtight space, an air passage with a “rectangular” cross section is formed behind the LED accommodation portion, and thus air current through the air passage allows easy heat dissipation.

According to the present invention, in the LED backlight constructed as described above, on both sides of the base across the board fitting face, a reflective surface is provided with such an inclination as to fan toward the liquid crystal panel, so as to reflect the light emitted from the LEDs toward the liquid crystal panel. With this construction, it is possible to illuminate a wide area; thus, even with a construction where LEDs are arranged in one vertical row, it is possible to form a display device with a large planar area, and it is thus possible to obtain an LED backlight that can stabilize light emission luminance and lifetime and thereby improve reliability.

According to the present invention, in the LED backlight constructed as described above, the LEDs are composed of groups of LEDs in three vertical rows including main LEDs arranged in a row at a predetermined pitch in the plumb-line direction and first and second sub LEDs provided on both sides of the main LEDs and illuminating regions predetermined angles apart respectively. With this construction, it is possible to obtain an LED backlight that has even illuminance at side-end parts which are difficult to illuminate evenly with the row of main LEDs alone.

According to the present invention, in the LED backlight constructed as described above, a heat-dissipating fin is provided in the passage. With this construction, heat dissipation performance is further enhanced; thus, it is possible to obtain an LED backlight that reliably dissipates heat even when a plurality of LEDs are used and that can stabilize light emission luminance and lifetime and thereby improve reliability.

According to the present invention, in the LED backlight constructed as described above, a slit member for preventing entry of foreign matter is provided in the passage. With this construction, while entry of pests and foreign matter is prevented, air flows in through an air inlet portion so that heat dissipation is achieved by convection of air.

According to the present invention, in the LED backlight constructed as described above, a cable accommodation portion is provided in the passage. With this construction, a cable can be laid so as not to pass the light emission region; this makes wiring easy, and makes even illumination possible without producing a shadow in an optical portion.

According to the present invention, a liquid crystal display device is provided with a liquid crystal panel and the LED backlight according to any one of claims 1 to 8. With this construction, it is possible to obtain a liquid crystal display device that can stabilize light emission luminance and lifetime and thereby improve reliability. It is also possible to obtain a liquid crystal display device that can reduce the number of LEDs provided and can be made compact.

### Advantageous Effects of the Invention

According to the present invention, LEDs are arranged at a predetermined pitch from top to bottom in the plumb-line direction of the base, and an air passage is formed in the plumb-line direction behind the base. Thus, even when the LEDs generate heat, air current through the passage formed in the vertical direction behind the base allows easy heat dissipation. Thus, it is possible to obtain an LED backlight that, even when fewer LEDs are provided and electric power concentrates on the fewer LEDs, prevents the temperature of the LEDs from becoming excessively high and that can stabilize light emission luminance and lifetime and thereby improve reliability.

### BRIEF DESCRIPTION OF DRAWINGS

FIG. 1 is a schematic illustrative diagram of a liquid crystal display device provided with an LED backlight according to a first embodiment of the invention;

FIG. 2 is a partial enlarged view of the LED backlight according to the first embodiment;

FIG. 3 is a partial enlarged perspective view of the LED backlight according to the first embodiment;

FIG. 4 is a partial enlarged perspective view of the rear side of FIG. 3;

FIG. 5 is a schematic illustrative diagram of a liquid crystal display device provided with an LED backlight according to a second embodiment of the invention;

FIG. 6A is a partial enlarged perspective view of a modified example of the LED backlight according to the first embodiment;

FIG. 6B is a schematic illustrative diagram showing an example of an air inlet member having a large number of small holes;

FIG. 6C is a schematic illustrative diagram showing an example of an air inlet member having a large number of elongate openings;

FIG. 7 is a schematic illustrative diagram of a liquid crystal display device provided with an LED backlight according to a third embodiment of the invention;

FIG. 8 is a partial enlarged view of the LED backlight shown in FIG. 7;

FIG. 9 is a schematic perspective view of a modified example where the hollow space is used as a cable accommodation portion;

FIG. 10 is a partial enlarged view of an LED backlight of a modified example provided with groups of LEDs in three vertical rows;

FIG. 11 is a diagram showing a light intensity characteristic required in an LED light source with respect to radiation angle;

FIG. 12A is a diagram showing an example of the light intensity distribution on the backlight surface as observed when main LEDs alone are used;

FIG. 12B is a diagram showing an example of the light intensity distribution on the backlight surface as observed when sub LEDs alone are used;

FIG. 12C is a diagram showing an example of the light intensity distribution on the backlight surface as observed when both main and sub LEDs are used together; and

FIG. 13 is a schematic illustrative diagram showing a construction of a conventional LED backlight.

### DESCRIPTION OF EMBODIMENTS

Embodiments of the present invention will be described below with reference to the accompanying drawings. The same components are identified by the same reference signs throughout, and no overlapping description will be repeated unless necessary.

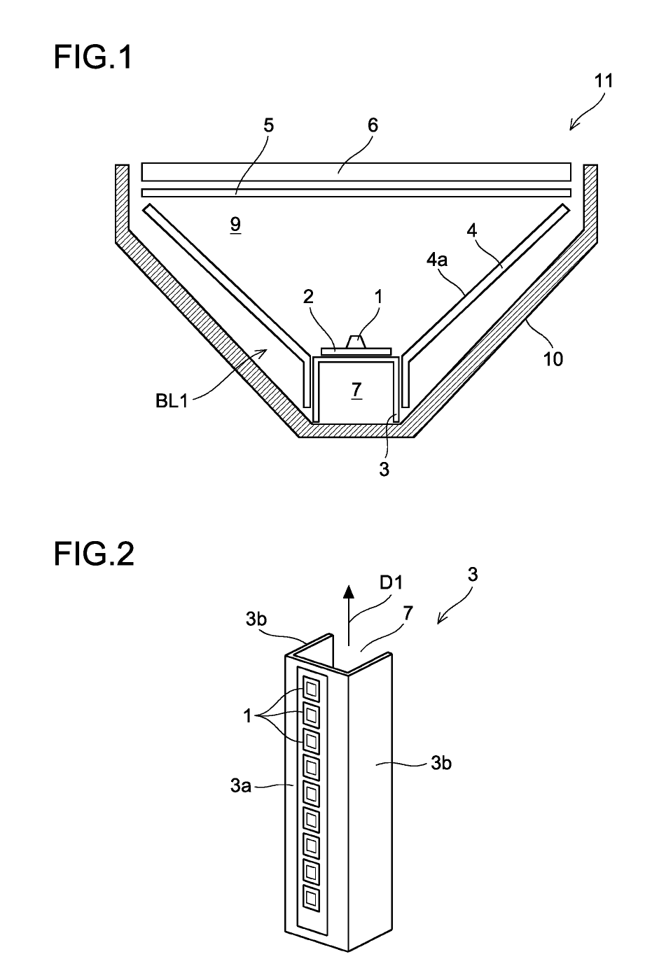

First, with reference to FIG. 1, an example of an LED backlight according to the invention will be described.

FIG. 1 shows a liquid crystal display device 11 provided with an LED backlight BL1 according to a first embodiment of the invention. The LED backlight BL1 is provided with an LED board 2 having a plurality of LEDs 1 arranged in a row in one axial direction and a base 3 having a board fitting face 3a on which the LED board 2 is fitted. The LED backlight BL1 is, along with a diffuser plate 5 and a liquid crystal panel 6, assembled into a frame member 10 to build a liquid crystal display device 11.

FIG. 1 is a plan view of the liquid crystal display device 11. As shown in FIG. 2, the base 3 is fitted to the frame member 10 with the above-mentioned one axial direction aligned with the plumb-line direction. Thus, the plurality of LEDs 1 are arranged one over another in the plumb-line direction. The base 3 has, in addition to the board fitting face 3a, side wall portions that form a hollow space behind the board fitting face 3a and thereby provide a passage through which air passes. So that the liquid crystal panel 6 may be illuminated over a wide area via the plurality of the LEDs 1 arranged in one vertical row in the plumb-line direction, the LED backlight BL1 may further be provided with a reflective member 4 which reflects the light emitted from the LEDs 1 toward the diffuser plate 5.

The diffuser plate 5 is an optical component in the form of a thin plate or a film that diffuses the light emitted from the LEDs 1 to distribute it over the entire area of the liquid crystal panel 6.

The liquid crystal panel 6 is composed of two transparent glass substrates with a liquid crystal material sealed between them and with color filters and polarizing filters stacked on them. Via switching elements formed in the form of a lattice, a large number of pixels are formed in the form of a lattice. By varying the voltages fed to the switching elements, the orientation of liquid crystal is changed, and thereby the amounts of light transmitted through the pixels are controlled so that a predetermined image is displayed on the top face of the liquid crystal panel 6.

The light emission region between the LEDs 1 and the liquid crystal panel 6 is generally made airtight to increase the efficiency of use of the light of the LEDs 1 and to prevent inconveniences like foreign matter such as dust entering and being displayed on the screen. Thus, the light emission region where the LEDs 1 are provided is an airtight space 9. In the drawings, for convenience' sake, the relevant members are shown apart from one another and the light emission region appears to be not airtight; in reality, it is airtight.

As shown in FIG. 2, on the base 3, which has a shape extending in the plumb-line direction, the plurality of LEDs 1 are arranged in one vertical row at a predetermined pitch. The base 3 is, for example as shown in the figure, a base with a square-cornered C-shaped cross section which has the board fitting face 3a and, on both its sides, side frames 3b, 3b bent approximately perpendicularly from the board fitting face 3a. Thus, the side frames 3b can be used as side frame portions that form a hollow space that is isolated from and does not communicate with the light emission region; thus, behind the board fitting face 3a, a hollow space 7 that extends in the vertical direction, that is, the plumb-line direction, can be formed.

As a result, when the LEDs 1 emit light and generate heat, the air behind the LEDs 1 is heated and produces an ascending air current, forming in the hollow space 7 a passage through which air passes from bottom to top. Thus, the hollow space 7 constitutes a “square-cornered C-shaped” air passage.

Moreover, the hollow space 7 is a space that is isolated from and does not communicate with the airtight space 9 between the liquid crystal panel 6 and the LEDs 1; it therefore does not need to be made airtight and can be left as an open space that communicates with outside air. That is, the air current through the hollow space 7, by convection of air, allows the heat generated by the LEDs 1 to dissipate, and thereby prevents an abnormal rise in the temperature of the LEDs 1. Thus, a construction having an air passage running in the plumb-line direction behind the board fitting face 3a is preferred because it has a heat dissipation structure that exerts the chimney effect.

As described above, with a construction provided with a frame member 10 to which a liquid crystal panel 6 and LEDs 1 are integrally attached, a base 3 extending from top to bottom in the plumb-line direction of the frame member 10, and an LED board 2 fitted to the base 3 and on which a plurality of LEDs 1 are amounted at a predetermined pitch in the plumb-line direction, wherein behind the LED board fitting face of the base 3 is provided a passage through which air passes, even when the LEDs 1, which are arranged one over another in the plumb-line direction of the base 3, generate heat, air passes through the air passage formed in the plumb-line direction behind the base 3, and allows easy heat dissipation. Thus, it is possible to obtain an LED backlight BL1 that prevents the temperature of the LEDs 1 from becoming excessively high and that can stabilize light emission luminance and lifetime and thereby improve reliability. By employing this LED backlight to illuminate a wide area, it is possible to obtain a liquid crystal display device 1 that can be made compact and that offers stable light emission luminance and lifetime and hence improved reliability.

It is preferable that, on both sides of the base 3 across the board fitting face 3a, a reflective member 4 be provided which has a reflective surface 4a so inclined as to fan toward the liquid crystal panel 6 so that the light emitted from the LEDs 1 is reflected toward the liquid crystal panel 6. With this construction, via the LEDs 1 provided approximately in a central part behind the liquid crystal panel 6, a wide area in the horizontal direction can be illuminated. Thus, even with a construction having LEDs 1 arranged in one vertical row, it is possible to form a display device with a wide area. Thus, it is possible to obtain an LED backlight BL1 that, despite being provided with a small number of LEDs, can cope with a liquid crystal panel 6 with a wide area and that can stabilize light emission luminance and lifetime and thereby improve reliability.

The reflective member 4 has only to have a reflective surface 4a that has high reflectance to the light emitted from the LEDs 1. For example, in a case where the LEDs 1 are a white light source, the reflective member 4 can be formed as a member that efficiently reflects visible light. It can instead be formed as a member of resin or the like laid with a reflective film of polyester-based resin used for efficient reflection of visible light (about 400 nm to 800 nm).

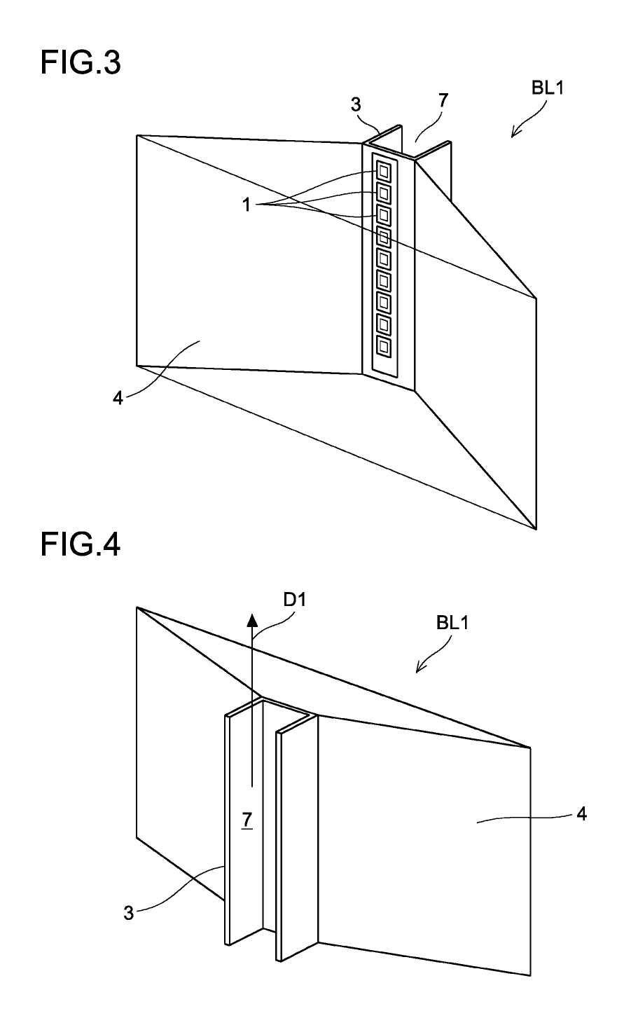

It is preferable that the base 3 be a base with a square-cornered C-shaped cross section as shown in FIGS. 3 and 4. In that case, the open part of the square-cornered C-shaped cross section constitutes the hollow space 7. In this way, by adopting a square-cornered C-shaped cross section which forms a hollow space 7 extending from top to bottom in the plumb-line direction, and using the hollow space 7 as an air passage, even when the light emission region between the back of the liquid crystal panel and the LED accommodation portion is an airtight space, it is possible to form an air passage with a “square-cornered C-shaped cross section in the plumb-line direction behind the LED accommodation portion so that air current through the air passage allows easy heat dissipation by convection of air.

The LED backlight BL1 shown in FIG. 3 is a backlight that can be used in liquid crystal display devices for compact televisions for instance, and has a plurality of LEDs 1 arranged behind the display screen. Moreover, even with a construction where, on both sides of the base 3, a reflective member 4 inclined toward the display screen is provided and LEDs are arranged in one vertical row in the plumb-line direction in a central part, it is possible to illuminate the entire area of the display screen with a far larger area.

In the LED backlight BL1 provided with the base 3 having a square-cornered cross section, as shown in FIG. 4, there is an open space behind the board fitting face 3a, and this open space can be used as an air passage through which to pass air for air cooling.

If the base 3 is a good thermal conductor, heat conducts from the LED board 2 on which the LEDs 1 are mounted to the base 3. Thus, with the air current D1 through the hollow space 7 as an air passage, it is possible to dissipate heat efficiently. Accordingly, it is preferable that the base 3 be formed of sheet metal, or heat-conductive hard resin.

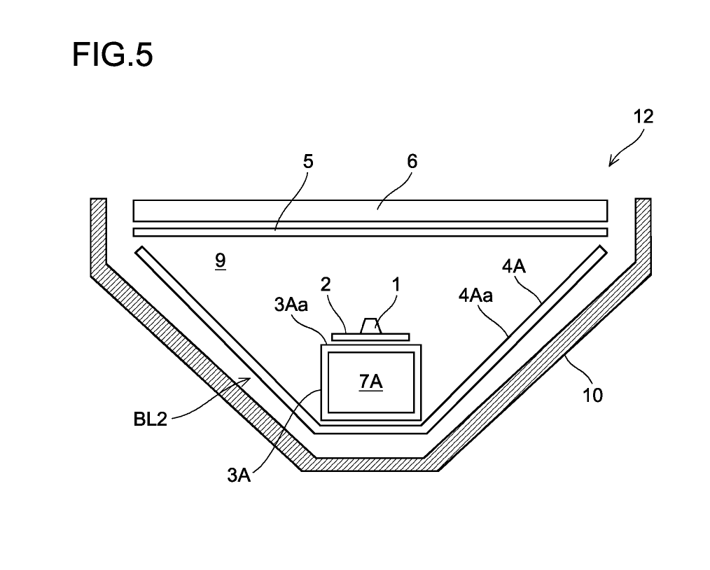

The base may be given any other shape than a square-cornered C-shaped cross section as described above. For example, it may have a rectangular cross section. Now, with reference to FIG. 5, an LED backlight BL2 provided with a base having a rectangular cross section (a second embodiment of the invention) will be described.

FIG. 5 shows a liquid crystal display device 12 provided with an LED backlight BL2 according to the second embodiment, a diffuser plate 5, and a liquid crystal panel 6. Like the LED backlight BL1 according to the first embodiment, the LED backlight BL2 has, assembled into a frame member 10, an LED board 2 having LEDs 1 mounted on it, a base on which the LED board 2 is fitted, and a reflective member 4A having a reflective surface 4Aa for reflecting the light emitted from the LEDs 1 toward the diffuser plate 5.

A difference is that the base here is a base 3A in the form of a rectangular pipe having a hollow space from top to bottom in the plumb-line direction. Accordingly, the base 3A in this embodiment has an LED board fitting face 3Aa and three side frames contiguous with it so as to have a rectangular shape with a rectangular cross section, and the hollow space in its central part constitutes a hollow space 7A as an air passage.

With the construction described above, even when the light emission region between the back of the liquid crystal panel 6 and the LED accommodation portion is an airtight space, an air passage with a “rectangular” cross section is formed behind the LED accommodation portion so that air current through the air passage allows easy heat dissipation. That is, the hollow space 7A exerts the chimney effect and thereby allows dissipation of the heat of the LEDs 1 and the LED board 2.

Moreover, the base 3A in the form of a rectangular pipe can be provided so as to protrude from the reflective member 4A into the airtight space 9, and this helps suppress an increase in the thickness of the liquid crystal display device 12. Thus, even with the construction provided with the base 3A in the form of a rectangular pipe, it is possible to keep the liquid crystal display device 12 from becoming thick and make it slim.

As described above, the hollow space 7A is an independent space that does not communicate with and is isolated from the airtight space 9. Thus, by making the hollow space 7A communicate with outside air, it is possible to use it as an air passage for air cooling. Thus, it is possible to use the hollow space 7A as a heat-dissipating means which exerts the chimney effect.

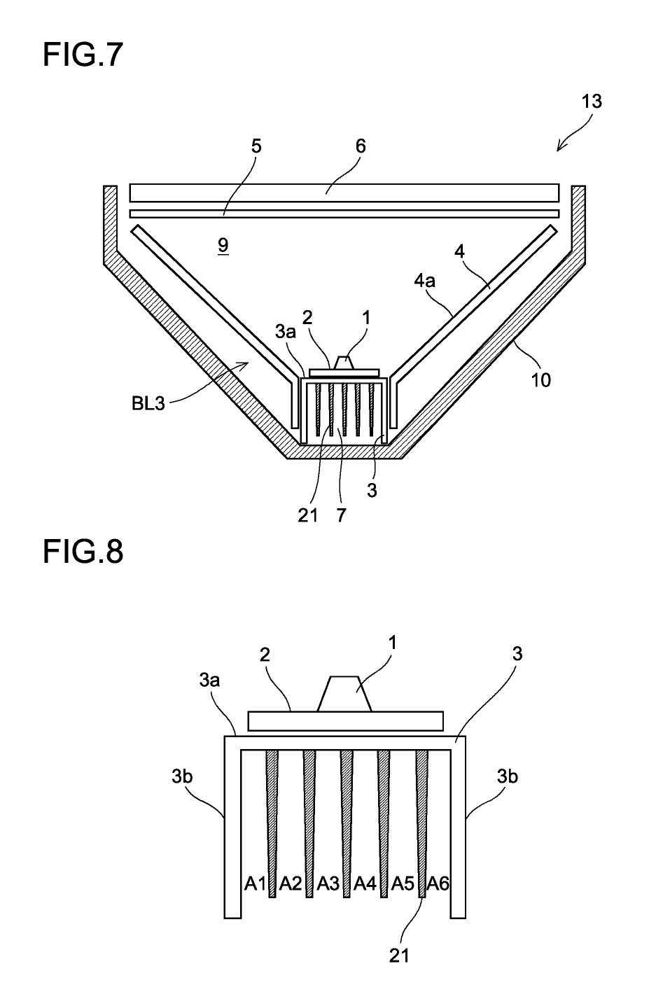

Irrespective of whether a base 3A in the form of a rectangular pipe is used or a base 3 with a square-cornered C-shaped cross section is used, for improved heat dissipation, a heat-dissipating fin may be provided in the air passage. For example, the liquid crystal display device 13 shown in FIG. 7 is provided with an LED backlight BL3 provided with a plurality of heat-dissipating fins 21 in the form of plates extending in the plumb-line direction of the hollow space 7 (the direction penetrating the plane of the figure).

With the LED backlight BL3 constructed as described above, the entire surface of the heat-dissipating fins 21 acts as a heat-dissipating surface, resulting in an increased heat-dissipating area and hence enhanced heat dissipation. Moreover, with the construction where plate-shaped fins are provided in the plumb-line direction of hollow space 7, the plurality of plate-shaped fins act as current-regulating plates that regulates the current of air. This allows smooth passage of air through the hollow space 7, and thus helps further enhance heat dissipation.

For example, as shown in FIG. 8, the heat-dissipating fins 21 provided in the hollow space 7 form, between the side frames 3b of the base 3, current-regulating paths A1, A2, . . . A6. A construction where heat-dissipating fins 21 are provided in the air passage in this way offers further enhanced heat dissipation performance; thus, it is possible to obtain an LED backlight BL3 that, even when a plurality of LEDs are used, dissipates heat reliably and that has stable light emission luminance and lifetime and hence improved reliability.

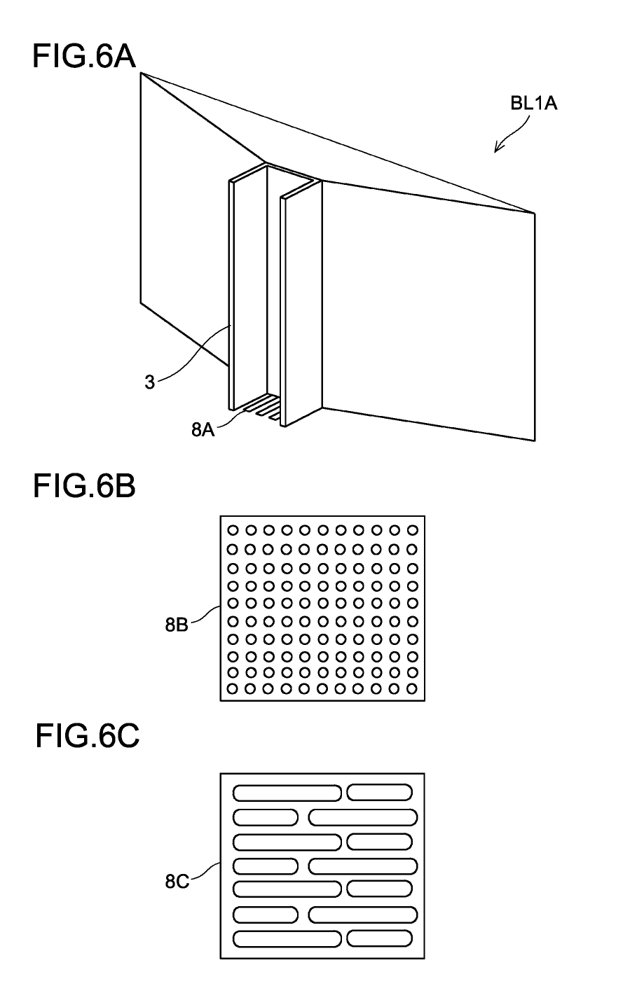

As shown in FIG. 6A, in the hollow space 7 of the base 3, a slit member 8A may be provided to form an air inlet portion that allows entry of air but prevents entry of pests such as cockroaches and dust. With an LED backlight BL1A so constructed, while pests and foreign matter are prevented from entering, air enters through the air inlet portion and exerts a heat-dissipating effect by convection of air.

Instead of the slit member 8A, an air inlet member 8B having a large number of small hole as shown in FIG. 6B, or an air inlet member 8C having a large number of elongate openings as shown in FIG. 6C may be provided. These air inlet members can be formed as pieces of punched sheet metal or moldings of resin of any of various materials.

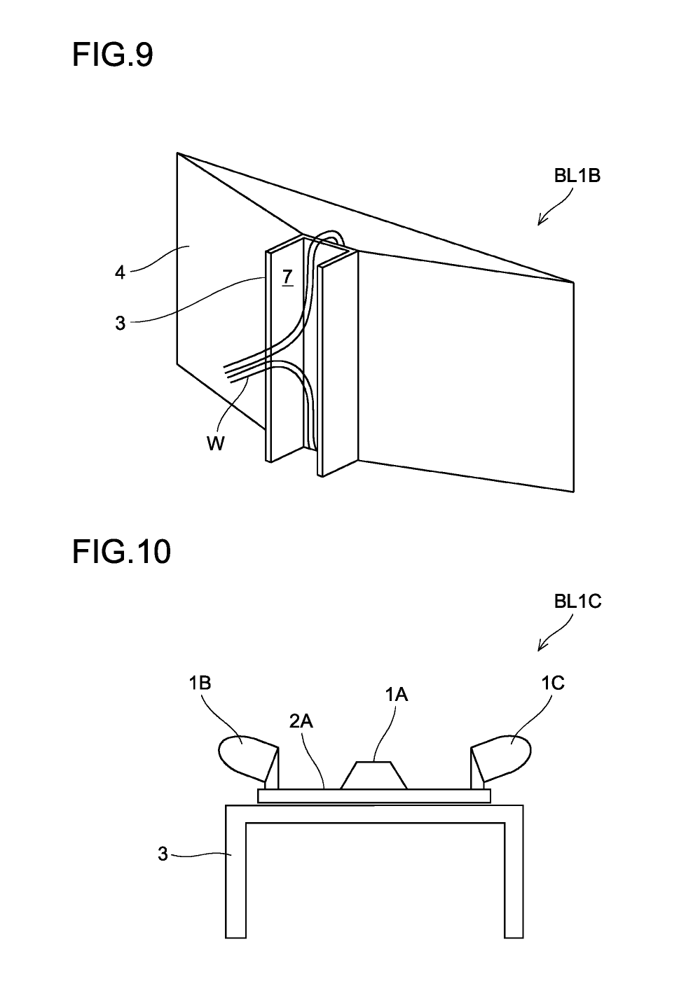

With a construction where a hollow space 7 is provided behind the LED board fitting portion 3a as shown in FIG. 9, the hollow space 7 can be used as a cable accommodation portion. In that case, an LED backlight BL1B constructed to have a slit member 8A as an air inlet member is suitable because it does not obstruct the passage of a cable K.

With the construction where a cable K is passed through the hollow space 7, the cable K is passed through a portion unrelated to the light emission region that is irradiated with backlight or from which backlight emanates. Thus, no shadow is optically produced, and even irradiation with backlight is possible.

Moreover, wiring can be laid along the back of the LED board 2. Thus, even with a configuration provided with a large number of LEDs 1, wiring is advantageously easy.

As described above, with a construction where a cable accommodation portion is provided in the air passage, a cable K can be laid so as not to pass the light emission region. This makes wiring easy, prevents shadows from appearing in an optical portion, and makes even illumination possible.

Next, with reference to FIGS. 10, 11, and 12A to 12C, a modified example of an LED backlight provided with, in addition to main LEDs in a central part, sub LEDs to the side of the main LEDs.

The LED backlight BL1C shown in FIG. 10 is provided with, as LEDs, main LEDs 1A arranged in a row at a predetermined pitch from top to bottom (in the direction penetrating the plane of the figure) in a central part in the axial direction of the base 3 and first sub LEDs 1B and second sub LEDs 1C provided on both sides of the main LEDs 1A so as to illuminate regions predetermined angles apart respectively. With this construction, wide-angle illumination is possible from groups of LEDs arranged in three vertical rows in the plumb-line direction.

In this LED backlight BL1C, since it is difficult to cover the light intensity distribution from 90° on one side to 90° on the other (−90° to +90°) with a single row of main LEDs 1A in a central part, to boost the light intensity in both side-end parts which cannot be sufficiently covered by the main LEDs 1A, the subsidiary sub LEDs 1B and 1C are arranged on the left and right sides of the main LEDs 1A. This construction is preferable because it helps make the planar distribution of the backlight wider and more even.

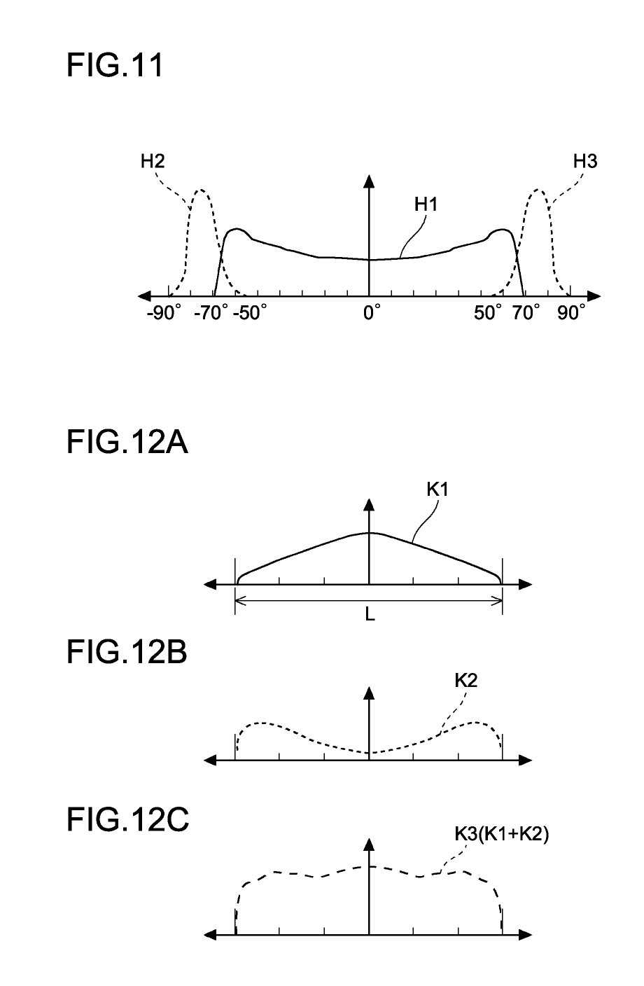

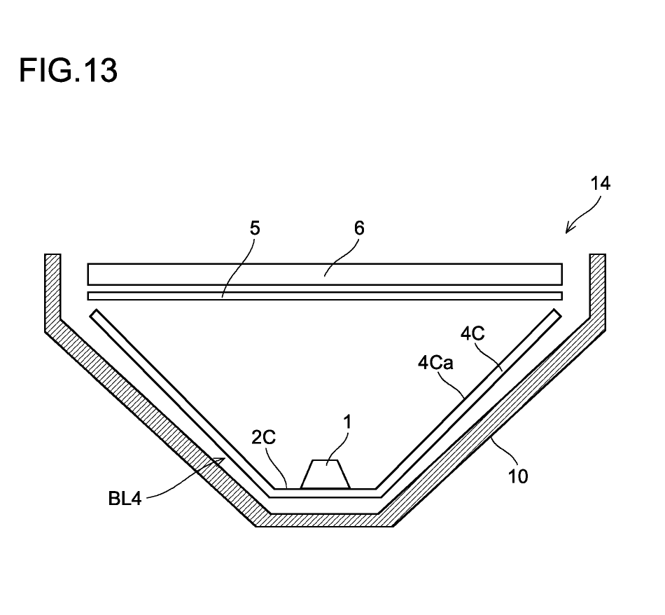

For example, in an LED backlight BL1 like the one shown in FIG. 1 that is provided with a plurality of LEDs 1 in one vertical row in the plumb-line direction and that is so constructed as to illuminate a wide area via a reflective member 4, the light emission intensity characteristic required in the LEDs 1 (corresponding to the main LEDs 1A) for even irradiation of the diffuser plate 5 with backlight is the light intensity H1 indicated by a solid line in FIG. 11.

As the light intensity H1 suggests, increasing the light intensity in regions diffused ±60° compared with that in a central part leads to more even backlight illumination. For illumination of a wider area (at a wider angle), it is advisable, as indicated by broken lines in the figure, to make the first sub LEDs radiate with the light intensity H2 and make the second sub LEDs radiate with the light intensity H3.

FIGS. 12A to 12C show light intensity distributions on a backlight surface with a width of L. FIG. 12A shows the light intensity distribution K1 obtained when the main LEDs alone are lit, FIG. 12B shows the light intensity distribution K2 obtained when the sub LEDs alone are lit, and FIG. 12C shows the light intensity distribution K3 obtained when the main and sub LEDs are lit simultaneously. The light intensity distribution K3 is thus the sum of the light intensity distributions K1 and K2, namely (K1+K2).

As will be clear from the figures, when the main LEDs alone are lit, light intensity is lower in side-end parts of the backlight surface in its width direction than in a central part; by using the main and sub LEDs together, it is possible to make the light intensity on the backlight surface substantially even.

As described above, it is preferable that the LEDs used in a direct-lit backlight where a plurality of LEDs are arranged in the plumb-line direction in a central part behind a liquid crystal panel be composed of groups of LEDs in three vertical rows including main LEDs arranged at a predetermined pitch in the vertical direction in a central part behind the liquid crystal panel and first and second sub LEDs illuminating regions predetermined angles apart respectively. With this construction, it is possible to obtain an LED backlight with enhanced evenness in light intensity in side-end parts of the display screen which is difficult to achieve with a row of main LEDs alone.

The example described above which includes groups of LEDs in three vertical rows is an example that includes a reflective member 4. In a case where LEDs radiating at a wide angle are used, or depending on the size of the LED backlight, without the use of the reflective member 4, by use of the groups of LEDs in three vertical rows alone, it is possible to make the light intensity on the backlight surface substantially even.

As described above, according to the present invention, a plurality of LEDs are arranged at a predetermined pitch from top to bottom in the plumb-line direction of the base on which an LED board is fitted, and an air passage is formed in the plumb-line direction behind the base. Thus, even when the plurality of LEDs generate heat, air current through the passage formed in the vertical direction behind the base allows easy heat dissipation. Thus, it is possible to obtain an LED backlight that prevents the temperature of the LEDs from becoming excessively high and that can stabilize light emission luminance and lifetime and thereby improve reliability.

Moreover, by adopting a construction where a reflective surface is provided on both sides of the base with such an inclination as to fan toward the liquid crystal panel, it is possible to illuminate a wide area with the light of the LEDs; thus, even with a construction having LEDs arranged in one vertical row, it is possible to form a lighting device (backlight) with a large planar area, and thus it is possible to obtain an LED backlight that can stabilize light emission luminance and lifetime and thereby improve reliability.

As discussed above, with an LED backlight according to the invention, even though it is constructed to have a plurality of LEDs arranged in a row in the vertical direction, since it is constructed to have a hollow space serving as an air passage behind a base on which an LED board is fitted, it is possible to dissipate the heat of the LEDs, and thus to prolong the lifetime of the LEDs and enhance reliability.

Moreover, it is possible to obtain an LED backlight that, even when fewer LEDs are provided and electric power concentrates on those fewer LEDs, prevents the temperature of the LEDs from becoming excessively high and that can stabilize light emission luminance and lifetime and thereby improve reliability.

### INDUSTRIAL APPLICABILITY

Accordingly, LED backlights according to the present invention can suitably be used as LED backlights for liquid crystal display devices that, despite being provided with fewer LEDs, can stabilize light emission luminance and lifetime and thereby improve reliability.

### LIST OF REFERENCE SIGNS

1 LED

1A main LED

1B, 1C sub LED

2 LED board

3, 3A base

3a, 3Aa board fitting face

3b side frame

4 reflective member

4a reflective surface

5 diffuser plate

6 liquid crystal panel

7, 7A hollow space (air passage)

10 frame member

11, 12, 13 liquid crystal display device (of the invention)

14 liquid crystal display device (conventional)

BL1 LED backlight (1st embodiment)

BL2 LED backlight (2nd embodiment)

BL3 LED backlight (third embodiment)

BL4 LED backlight (conventional)

21 heat-dissipating fin

D1 air current

1. An LED backlight that is fitted to a frame member of a liquid crystal display device provided with a liquid crystal panel and that irradiates the liquid crystal panel from behind with light emitted from LEDs, comprising:
an LED board on which a plurality of the LEDs are mounted in one axial direction; and
a base to which the LED board is fitted, wherein
the base has
a board fitting face to which the LED board is fitted such that the LEDs are exposed to a light emission region between the LEDs and the liquid crystal panel and
a side frame portion which forms, behind the board fitting face, a hollow space that is isolated from and does not communicate with the light emission region, and
the base is fitted to the frame member with the one axial direction aligned with a plumb-line direction such that, in the hollow space, a passage that runs in the plumb-line direction is formed through which air passes.

2. The LED backlight according to claim 1, wherein the base has a square-cornered C-shaped cross section by comprising the board fitting face, which extends in the plumb-line direction, and side frames, which are provided on both sides of the board fitting face and are bent approximately perpendicularly therefrom, an open part of the square-cornered C-shaped cross section serving as the passage.

3. The LED backlight according to claim 1, wherein the base is in a form of a rectangular pipe having a rectangular cross section by comprising the board fitting face, which extends in the plumb-line direction, and three side frames, which are contiguous with the board fitting face, a hollow part inside the rectangular cross section serving as the passage.

4. The LED backlight according to claim 1, wherein
on both sides of the base across the board fitting face, a reflective surface is provided with such an inclination as to fan toward the liquid crystal panel, so as to reflect the light emitted from the LEDs toward the liquid crystal panel.

5. The LED backlight according to claim 1, wherein
the LEDs comprise groups of LEDs in three vertical rows including main LEDs arranged in a row at a predetermined pitch in the plumb-line direction and first and second sub LEDs provided on both sides of the main LEDs and illuminating regions predetermined angles apart respectively.

6. The LED backlight according to claim 1, wherein
a heat-dissipating fin is provided in the passage.

7. The LED backlight according to claim 1, wherein
a slit member for preventing entry of foreign matter is provided in the passage.

8. The LED backlight according to claim 1, wherein
a cable accommodation portion is provided in the passage.

9. A liquid crystal display device comprising a liquid crystal panel and the LED backlight according to claim 1.
